(19) United States
(12) Patent Application Publication
(10) Pub. No.: US 2008/0017304 A1
(43) Pub. Date: Jan. 24, 2008

(54) PARTS WITH EDGES OF PLASTIC AND FABRIC AND PROCESSES FOR THEIR PRODUCTION

(75) Inventors: Steven A. Sell, Midland, MI (US); Brent A. Salamon, Midland, MI (US); Michael E. Hus, Midland, MI (US); Jeffrey D. Wenzel, Saginaw, MI (US); James R. Ogle, Austin, TX (US)

Correspondence Address: DOBRUSIN & THENNISCH PC, 29 W. LAWRENCE STREET, STE. 210, PONTIAC, MI, 48342, US

(73) Assignee: Dow Global Technologies Inc.

(21) Appl. No.: 11/530,594

(22) Filed: Sep. 11, 2006

Related U.S. Application Data
(60) Provisional application No. 60/807,983, filed on Jul. 21, 2006.

(51) Int. Cl. B32B 37/00

(52) U.S. Cl. 156/250

(57) ABSTRACT

The present invention provides a fabric-laminated plastic part comprising of a surface fabric laminated to a plastic substrate. The part typically includes one or more edges having a portion of the fabric being flush with a portion of the substrate at those edges. The invention also provides a novel process of forming a part with the one or more flush edges.

### CLAIM OF PRIORITY

This application claims the benefit of the filing date of U.S. Provisional Application No. 60/807,983 filed Jul. 31, 2006.

### TECHNICAL FIELD

This invention relates to parts having a plastic substrate and a fabric disposed thereon and a process for making these parts particularly where an edge of the fabric is substantially flush with an edge of the plastic. Such parts can be produced with desirable appearance, consistent edge configuration, desirable part shapes and configurations, combinations there or the like.

### BACKGROUND OF THE INVENTION

For many years, industry has been forming parts for various articles of manufacture by attaching fabrics to plastic substrates, Such fabrics can provide desirable attributes to these parts such as a desirable aesthetic appearance, desirable contact surfaces (e.g., for gripping or general feel), part or article protection, relatively simple design variability (e.g., through the use of different fabrics), combinations thereof or the like. Recent advances in the provision of fabrics to plastic substrates are disclosed in commonly owned patent application titled Molded Parts with Fabric Surface Areas and Process for Their Production, Ser. No. 11/361,787, filed Feb. 24, 2006 and U.S. Pat. No. 6,926,856 both of which are incorporated herein by reference for all purposes.

More recently, industry has shown a particular interest in parts that include a plastic substrate and a fabric attached to (e.g., laminated over) the substrate such that one or more edges of the fabric are substantially flush with one or more edges and/or intersecting surfaces of the plastic substrate. However, achievement of such flush edges, particularly within tight tolerances, can be quite difficult, As one example, molding of the substrate to the back of a fabric tends to move and/or stretch the fabric making alignment of an edge of the fabric with an edge of the substrate quite difficult. Therefore, the present invention provides an improved part that includes a plastic substrate with one or more edges that are substantially flush with one or more edges of a fabric. Moreover, the present invention provides a process for producing such a part.

### SUMMARY OF THE INVENTION

Accordingly, there is disclosed a process of forming a molded plastic part. The process includes provision of a fabric and attachment of the fabric to a plastic substrate to form a laminate. The laminate is then cut, which typically includes cutting of the fabric and the plastic substrate to form the part such that the part includes one or more edges having an edge of the fabric flush with an edge and/or surface of the plastic substrate. The step of cutting is typically accomplished with a tool that is being moved in rapid repetitive motion for assisting in accomplishing the cutting. The rapid repetitive motions can be selected from rotations, vibrations, oscillations or a combination thereof.

There is also disclosed a part that is comprised of a plastic substrate having an edge and/or surface and a fabric having an edge that is substantially flush with the edge and/or surface of the plastic substrate. The edge of the fabric, the edge and/or surface of the substrate or any combination thereof will typically include markings indicative of cutting of the fabric and substrate by a tool undergoing rapid repetitive motions. In one embodiment, the rapid repetitive motions are rotations and the markings are intermittent protrusions and grooves. The protrusions and grooves can be arcuate or otherwise shaped as they extend across the thickness of the substrate.

### BRIEF DESCRIPTION OF THE DRAWINGS

FIG. 1 is a schematic of an exemplary part being formed by an exemplary process in accordance with an aspect of the present invention.

FIGS. 2 and 3 are sectional views of an exemplar mold forming an exemplary laminate in accordance with an aspect of the present invention,

FIG. 4 is a side view of an exemplary tool suitable for use within a cutting step of the present invention.

FIG. 5 is an illustration of an exemplary cutting system according to an aspect of the present invention.

FIGS. 6A-6C show an exemplary cutting step according to an aspect of the present invention.

FIG. 7 is a top view of the exemplary cutting step as shown in 6B.

FIG. 8 is a close-up view of an exemplary flush edge in accordance with an aspect of the present invention.

FIG. 9 is a close-up view of exemplary markings formed during an exemplary cutting step in accordance with an aspect of the present invention.

FIGS. 10A-10C are sectional views of other exemplary flush edges formed in accordance with the present invention.

FIGS. 11 and 12 are close up views of other exemplary markings formed during exemplary cutting steps in accordance with aspects of the present invention.

FIG. 13 is a schematic depiction of exemplary cutting motions of a tool in accordance with an aspect of the present invention.

FIG. 14 shows exemplary cutting of contours according to one exemplary aspect of the present invention.

### DETAILED DESCRIPTION

The present invention is predicated upon the provision of a part having a fabric and a plastic substrate wherein the fabric overlays at least a portion of the plastic substrate and the fabric and the substrate cooperatively form one or more substantially continuous and/or substantially flush edges. Preferably, for each of the one or more substantially flush edges of the part, the fabric will include an edge that is substantially flush with an edge and/or a surface of the plastic substrate for forming the substantially continuous and/or substantially flush edge. Typically, flush edges of a part that are formed in accordance with the present invention are formed using a cutting operation and the edge of the fabric, the edge and/or surface of the plastic substrate or any combination thereof will typically include markings (e.g. contours) indicative of the cutting operation.

The present invention is further predicated upon the provision of a process of forming a part having one or more of the aforementioned substantially flush edges. The process typically includes one, two or any combination of the following steps.
1) providing of a fabric, which, can be provided as a fabric insert within a molding machine and/or which may or may not include a backing;
2) attaching the fabric to a plastic substrate, which can include molding a plastic material within the mold to form a plastic substrate adhered to the fabric insert; and/or
3) cutting the fabric and the plastic substrate to form the article such that the article includes one or more edges having an edge of the fabric flush with an edge and/or surface of the plastic substrate wherein the cutting can be accomplished by moving a tool in rapid repetitive motions and moving the tool in at least one dimension within a 3-dimensional space during the rapid repetitive motions.

Fabric

A wide range of fabric materials can be used for the fabric of this invention. This is a tremendous advantage of the parts and process that are provided according to the present invention. The suitable fabric materials include, but are not limited to: natural and synthetic leathers (including both leathers and suedes) and any types of textiles or textile-like materials such as, woven, non-woven, and knit fabrics from natural or synthetic fibers/materials including coagulated polyurethane laminates, PVC and other rigid or flexible film or sheet materials. The suitable “fabrics” may include laminates and structures combining two or more of the aforementioned materials. As one example of combined material, a fabric can include a material such as synthetic leather formed of a polymeric material (e.g., polyurethane) layered with a fibrous material such as a woven or unwoven fabric formed of polymeric (e.g. polyamide) or other strands or fibers. Although, the fabric may be partially or substantially rigid, it is typically preferable for the fabric to be “generally flexible” such that it does not typically return to a predetermined shape or configuration on its own after it is bent or otherwise deformed.

The fabric piece may also include one or more of the aforementioned materials with an adhered “backing material”. “Backing materials” are sometimes included on the fabrics or the backing materials can be added if needed. The backing materials can assist the fabric to adhere better to a plastic substrate, stiffen the fabric and/or prevent the molding plastic from being excessively forced into or through the back of the fabric. Backing materials can include a wide range of natural or synthetic materials or textiles including woven, non-woven, and knit fabrics from natural or synthetic fibers/materials; films, foams or sheets of a plastic (e.g., a thermoplastic) such as PC, PET, PBT, ABS, PA (e.g., nylon), PP, PE, HIPS, polystyrene (e.g., hydrogenated polystyrene) and blends of two or more of these materials. Although, the backing material may be partially or substantially flexible, it is typically preferable for the backing material to be “generally rigid” such that it can typically return to a predetermined shape or configuration on its own after it is bent or otherwise deformed in such a way that does not cause yielding of the backing material. Advantageously, lamination of the backing material to the fabric can often provide the fabric or overall laminate with a desired degree of rigidity. Moreover, the backing can provide rigidity to a normally elastic fabric thereby at least reducing the amount that such a fabric might stretch during molding of the substrate component, although not required unless otherwise stated.

In one embodiment of the present invention, a foam layer can advantageously be included as a backing material for the fabric or an intermediate layer between the fabric and the substrate material. When using a compressible type of foam, this can provide or enhance the soft or cushioned feel of the fabric surface. This layer can be present on the fabric that is supplied for use or can be laminated to a fabric either prior to or during the molding/lamination of the substrate. In general, the foam can be open or closed cell and needs to be sufficiently heat resistant to retain its desired properties during the subsequent processing steps, for example not melting or collapsing to an unacceptable degree. Suitable foam densities are in the range of from about 5 to about 95 kilograms per cubic meter (kg/m³), preferably from about 20 to about 75 kg/m³ , depending upon their layer thickness and degree of cushion or compression that is desired. The plastic material used in the foam can be a thermoset or thermoplastic and preferred foam plastic layers include a foamed thermoset polyurethane. Generally, in such an embodiment, it is contemplated that the fabric or intermediate layer can be bonded (e.g. adhered, vibration welded) to the foam layer across substantially an entire surface of the foam, fabric and/or intermediate layers or at the edges of such layers.

It is also contemplated that the fabric layer could be replaced with a layer of alternative material such as a relatively rigid wood layer, a metal layer (e.g., a foil or sheet of metal). Thus, the discussion about the fabric or fabric pieces herein, can also be applied to such layers of these alternative materials where suitable.

Substrate

The substrate of the present invention is typically plastic although it may include or be substantially entirely formed of one or more other materials. The term “plastic substrate”, as used herein, will generally encompass any material that includes a polymer unless otherwise defined. Preferably, the substrate is substantially formed of plastic and includes at least 40%, more typically at least 60% and even more typically at least 80% by weight and/or by volume plastic. It is also contemplated that the substrate can be formed of a highly filled plastic that include less than 40% (e.g., between about 7% and about 30%) by weight and/or by volume plastic.

Suitable plastic materials can include, without limitation, thermoset plastics such as polyurethane, epoxy or thermosetting silicone and thermoplastics such as polycarbonates (“PC”), ABS, polypropylene (“PP”), high impact polystyrene (“HIPS”), polyethylene (“PE”), polyester, polyacetyl, thermoplastic elastomers, thermoplastic polyurethanes (“TPU”), nylon, ionomer (e.g., Surlyn), polyvinyl chloride (“PVC”) and including blends of two or more of these thermoplastics and/or thermosets such as PC and ABS. These materials may contain pigments, additives and/or fillers that contribute any needed cost and/or performance features such as surface appearance, ignition resistance, modulus, toughness, EMI shielding and the like.

Formlation and Attachment

The plastic substrate can be formed according to a variety of techniques, which can include, without limitation, extrusion, thermoforming or the like. Typically, however, the plastic substrates according to the present invention are prepared using one or more of a selection of multiple molding techniques. Exemplary molding techniques include, without limitation, blow molding, injection molding, compression molding or the like.

Unless otherwise stated, a variety of attachment techniques may be employed to attach the plastic substrate to the fabric to form a laminate of the substrate and fabric. As used herein, the term “laminate” is used to designated a fabric layer overlaying a plastic substrate and can encompass most any configuration of a plastic mass in combination with a fabric. Preferably, however, the laminate and the part formed from the laminate have at least a portion of an outwardly facing exposed surface formed of the fabric.

The fabric may be attached to the substrate during formation (e.g., molding) of the substrate, after forming (e.g., molding ) of the substrate or a combination thereof to form the laminate. Suitable attachment and/or forming techniques include, without limitation, compression molding, adhesive securing (e.g., with thermoset foam or holt melt adhesive), radio frequency (RF) welding, sonic welding, thermoforming, injection compression molding, gas assist injection molding, structural foam injection molding, microcellular foam molding technology, laminar injection molding, water injection molding, external gas molding, shear controlled orientation molding, and gas counter pressure injection molding. Thermosetting or thermosettable plastics can also be employed to similarly prepare the plastic substrate and/or attach the substrate to the fabric using techniques such as reaction injection molding or resin transfer molding.

Generally, it is preferred that the fabric is adhered to the substrate during formation and particularly during molding of the plastic substrate. For example, a fabric, which may fit in a mold or may be oversized relative to the mold may be fed to a mold and a substrate may be backmolded to a portion or the entirety of the fabric to adhere the substrate and fabric, According to one preferred technique, a fabric insert or piece is located between at least two mold pars or dies (usually referred to as a “core” and a “Cavity”). The mold parts are brought together with the fabric piece therebetween such that a cavity is formed between the mold parts. A plastic material is then injected into the cavity such that the material hardens and forms into a plastic component substrate adhered to the fabric piece. The hardening of the plastic material can be brought about by cooling of the plastic material within the mold, by chemical reaction within the mold or both.

As mentioned above, this plastic substrate can be prepared by generally known molding techniques that are suited to provide the necessary plastic substrate or base part having the fabric properly located and sufficiently adhered thereto. A preferred molding technique is injection molding onto a pre-cut or otherwise shaped fabric insert that can be properly located and sufficiently fixed to an inner mold surface in an injection molding mold during the injection molding process. In the injection molding step molten plastic is injected into the mold, filling the mold, conforming the fabric insert to the mold shape and simultaneously laminating or bonding the fabric insert to the plastic. As will be discussed further below, the fabric insert can have a backing layer that facilitates the step or process of adhesion/lamination to the substrate component.

The mold surface of any of the mold parts can be textured to any known surface finish that is desired for either the exposed portion of the fabric insert, the appearance or texture of the exposed portions of the plastic material or provide a desired surface for subsequently attaching or affixing either the fabric or other components thereto. Then, during the injection step the plastic enters the mold, filling the mold, conforming the fabric insert, in so far as such conforming is needed or desired, to the mold shape and imparting the mold surface/grain/texture onto the fabric or substrate material surface.

The fabric, prior to, during and/or after attachment to the substrate, can have a two dimensional or three dimensional shape. The fabric may be pre-formed into a three dimensional shape prior to attachment (e.g., lamination) of the fabric to the substrate. For example, a fabric or fabric insert according to the present invention, may be shaped via hot or cold forming processes to have a three dimensional shape. Moreover, such a three dimensional shaped insert may be placed in a mold and its three-dimensional shape may correspond to a shape of the mold. Thereafter, the plastic substrate can be backmolded to the insert such that the substrate includes a similar or same shape. Alternatively or additionally, the molding of the substrate to the fabric insert may assist in imparting three dimensional shape to the fabric.

The fabric or fabric insert may be enclosed within the mold during molding. Alternatively, the fabric or fabric insert could be larger such that portions of the fabric extend outside of the molding during molding. In such an embodiment, the fabric may need to be trimmed after molding.

It is also contemplated that the fabric or the fabric insert can have openings (e.g., through-holes) extending therethrough for allowing the substrate to be seen at those openings. Such openings can be formed prior to or after the substrate has been attached (e.g., back-molded) to the fabric or fabric piece and the substrate may or may not extend into those openings. It is also contemplated that the substrate, the fabric or both could include aligned openings (e.g., a through-hole of the fabric aligned with an opening or through-hole of the substrate) or non-aligned openings upon removal of the part form the mold.

When a backing material is employed, the plastic material of a molded plastic substrate may be partially the same as, substantially exactly the same as or It different than the material used in the backing of the fabric insert when such backing is employed. Bonding of the backing material to the fabric can be achieved by flame lamination, adhesive bonding, electromagnetic radiation bonding, or thermally initiated adhesive such as Dow Adhesive Film or other processes as will be recognized by the skilled artisan. Examples of desirable adhesives include epoxy, polyurethane, polyester or other adhesive materials. As may be needed for facilitating fabrication of the part design, the fabric surface piece with optional backing can be cut, stamped out, shaped, formed and/or preformed by techniques such as the known deep drawing processes for preparing pre-formed shapes to be inserted into the mold. Examples of preferred processes include, without limitation, high pressure forming, vacuum pressure forming, matched metal or mold die forming processes, high or low pressure bladder forming, hydroforming, plug assist forming, combinations thereof or the like. Depending upon the design of the finished article, there can be different fabric types used in different surface sections of the article.

In general, the combinations of fabric, the lamination of the fabric and the material of the plastic substrate are selected to obtain sufficient adhesion between them. The adhesion between the fabric surface piece and plastic substrate is such that the fabric is not readily removed from the part during the subsequent processing, handling and or use of an article formed of the substrate and fabric. It is also possible to apply an adhesive to a back side of the backing or fabric resulting in a more robust connection between the substrate and the backing or fabric when the substrate is molded or otherwise attached to the to the back side thereof.

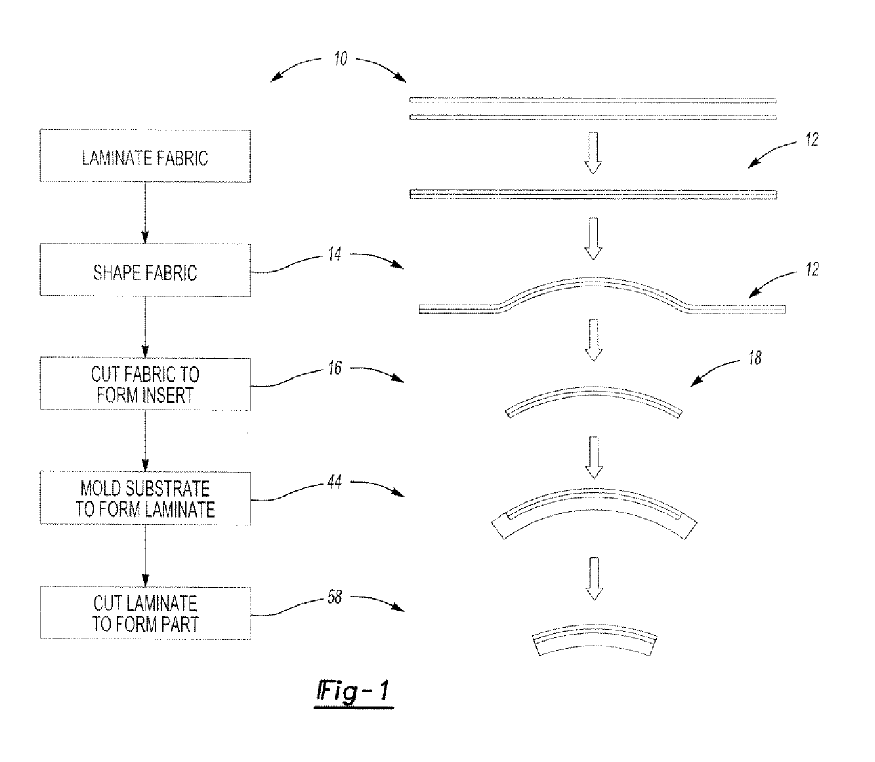

With reference to FIG. 1, a preferred exemplary process 10 is illustrated for forming a substrate/fabric laminate according to the present invention. As shown, a laminated fabric 12 is prepared according to one of the techniques discussed herein or otherwise. That fabric 12 is then shaped in a forming step 14 to include one or more contours such as arcs, bends, curves, cavities or the like and cut 16 to a desired size and/or configuration thereby forming a fabric insert 18. Generally, the fabric may be cut and then shaped, shaped and then cut or these activities may take place partially or entirely simultaneously.

In the embodiment depicted, the fabric 12 is shaped in the first forming step 14 and then cut. It is contemplated that shaping of the fabric 12 may be accomplished according to several techniques. Shaping may be part of the lamination process. Shaping might also be accomplished by physical deformation (e.g., bending) of the laminate fabric 12, for example at elevated temperatures. In a preferred embodiment, a forming die is employed to shape the fabric at an elevated temperature. For example, the fabric 12 can be shaped about a single forming die at an elevated temperature or the fabric 12 can be located between a first die and a second die and the fabric can be sandwiched between the dies at an elevated temperature for a predetermined period of time such that the fabric assumes a shape corresponding to the one or more dies. Shaping of the fabric can be accomplished at various temperatures and during various time spans depending upon the materials of the fabric. Advantageously, multiple sections of a single laminate fabric can be formed at substantially the same time with each of the sections corresponding to a fabric insert for a different part. Of course, it is also contemplated that the fabric may be unshaped and/or may simply be two dimensional.

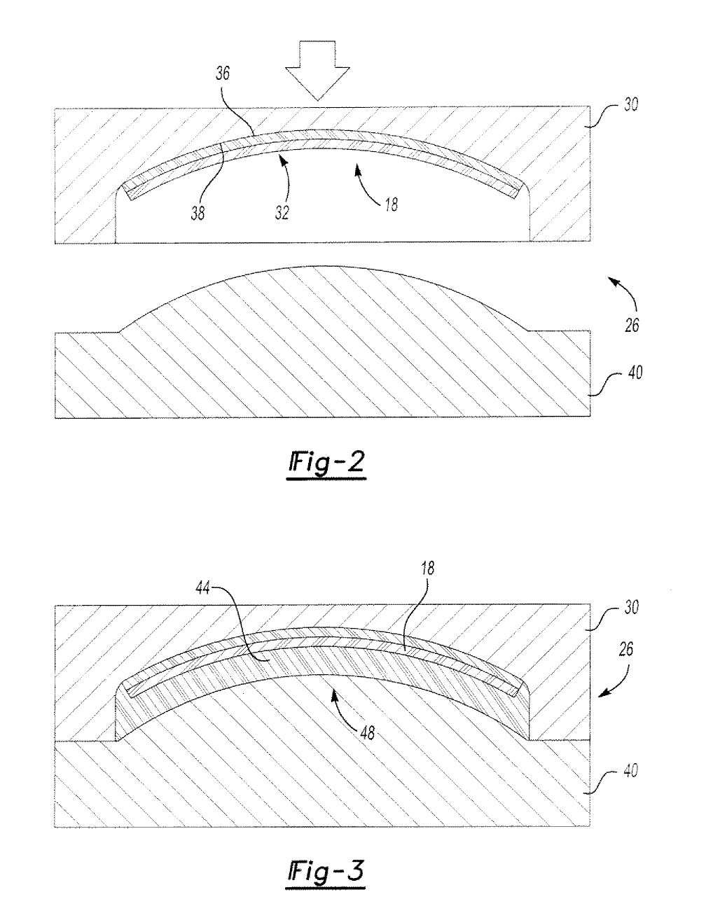

Referring additionally to FIG. 2, the fabric piece 18 is typically placed within a mold 26 of a molding machine (e.g., an injection, compression or other molding machine) In the illustrated embodiment, the fabric insert 18 is located adjacent or within a first die 30 of the mold 26 and held in place in the die such that a first surface 32 of the fabric insert 18 facing out of the die 30 and a second surface 36 of the fabric insert 18 facing and opposing a surface 38 of the die 30. The fabric piece 18 can be held in place relative to the mold 26, for example, by vacuum, pressure, mechanical features of the mold 26, nesting of the fabric piece with the mold combinations thereof or the like.

The mold 26 is then closed as shown in FIG. 3 (e.g., by moving the first die 30 and second die 40 together or toward each other) and the plastic material is fed (e.g., injected) into an opening within the mold 26. The conditions at which the plastic material is fed into the mold can vary depending upon the plastic material, the backing of the fabric insert and other factors. Generally, it has been found that temperatures between about 200° C. and about 450° C. and pressures (e.g., cavity pressures) between about 500 psi and about 40,000 psi are suitable for many applications although higher or lower temperatures and/or pressure may be employed.

Once fed (e.g., injected) into the opening of the mold 26, the plastic material forms a plastic substrate 44 that is adhered to substantially the entire back surface 32 of the fabric insert 18 thereby forming a molded plastic laminate 48 having the fabric 18 as at least one surface of the laminate 48. Preferably, the material does not flow onto the front surface 36 of the fabric leaving substantially the entirety of the front surface 36 of the fabric uncovered.

Once molding is completed, the molded plastic laminate 48 can be removed from the mold 26. Preferably, the laminate 48 is larger than the final part that is to be formed from the laminate 48. In particular, one or more edges of the laminate should extend beyond the desired dimensions of the final part such that those edges can be cut away to form flush edges on the part.

Cutting

Once the laminate is formed (e.g., during molding), it is preferably cut in a secondary operation. The term cutting as used herein can refer to the formation of any contour such as an opening, cavity, slit or the like upon or within the laminate, and such cutting can result in the removal of a portion of the laminate. It is contemplated that various cutting techniques can be employed, for example, laser cutting, knife cutting, water jet cutting, rotating wheel cutting or the like. Generally, it is preferred that cutting of the laminate be accomplished with a cutting tool or other object. Suitable tools can include, without limitation, die cutters, blades, saws, milling cutters, grinding cutters, wheel cutters, disc cutters. In a typical embodiment, the tool will be formed of a metal such as steel (which may be high speed) or carbide, a ceramic, a plastic or combinations thereof but may be formed of other materials as well.

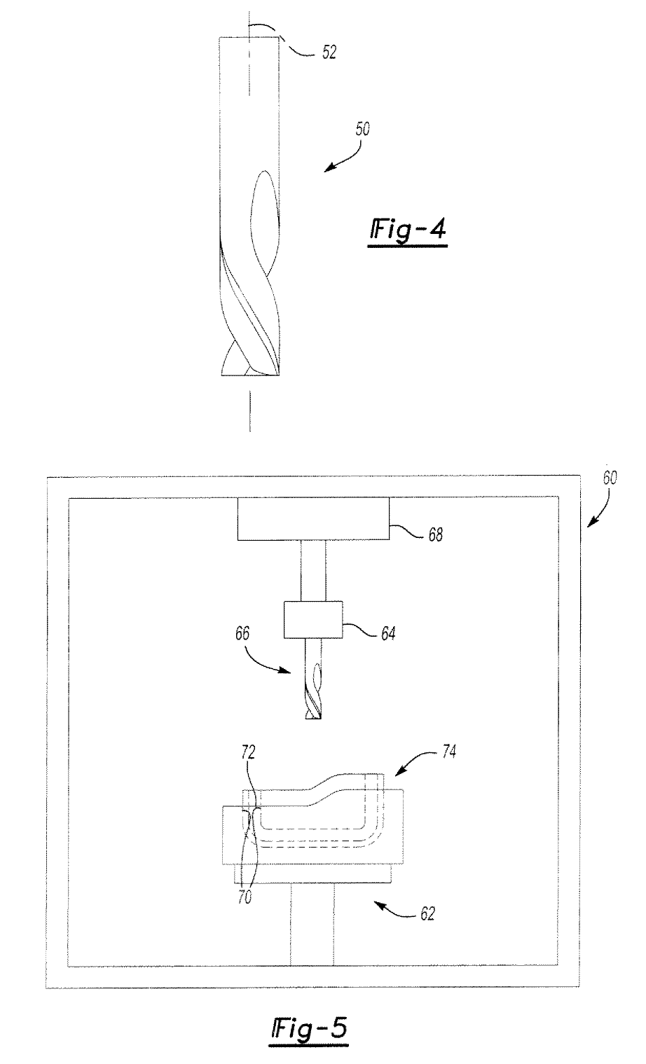

It is typically preferred that the cutting tool be configured for rapid repetitive motions. Such motions can include, without limitation, vibrations, rotations, oscillations, combinations thereof or the like. In one embodiment, the tool is configured for rotation about an axis of the tool such that the tool can contact the laminate and form cut edges on the laminate. The cut edges typically have a surface that can be parallel or skew to the axis of the tool (depending upon the type of tool used or other factors) as that surface is being formed, but which, in one embodiment, is preferably perpendicular to the axis of the tool. A particularly preferred tool is a mill, which can be a flat end mill, a ball nose mill, a beveled end mill, combinations thereof or otherwise which may include a single flute, 2 flutes, 4 flutes, reverse flute[s], straight flute[s], standard flute[s], combinations thereof or otherwise. In FIG. 4, a suitable flat end mill 50 is illustrated with an axis 52 extending along a length of the mill.

The tool, the laminate or both are preferably additionally configured for movement in at least one dimension, but more preferably at least two or three dimensions relative to each other within a 3-dimensional space, referred to herein as dimensional motion, during the rapid repetitive motions. This relative motion allows for cutting of the laminate to form the desired flush edges. Such relative motion can be accomplished by moving the laminate relative to the tool, the tool relative to the laminate or a combination thereof. By such motion, the tool, the laminate or both are moved relative to each other (e.g., toward, away and/or about each other) while the tool is simultaneously moved in its rapid repetitive motions (e.g., while the tool is rotated about its axis). Thus, the movement in one, two or three dimensions can be substantially separate and independent from the rapid repetitive motions.

The dimensional motion and the repetitive motions are preferably carried out in an automated manner by one or more automated apparatuses. For example, an automated apparatus or machine can include a mount configured to repetitively move (e.g., rotate) the tool and the same automated apparatus or a different automated apparatus can include a system (e.g., a track, a robot arm, a fixture or a combination thereof) to dimensionally move the tool, the laminate or both relative to each other.

It is typically desirable for the laminate to be mounted upon a fixture to assist in controlling and/or maintaining the location of the laminate relative to the tool, particularly during the cutting of the laminate. It is contemplated that the fixture may be substantially stationary or that a part or the entirety of the fixture may be movable for moving (e.g., for dimensionally moving) the laminate. In a preferred embodiment, the fixture includes surfaces for clamping the laminate adjacent one or more locations of the laminate that are to be cut and formed into flush edges. In a preferred embodiment, such clamping is typically within 3.0 cm, more typically within 1.0 cm, even more typically within 3.0 mm, possibly within 1.0 mm and even possibly within 0.25 mm or 0.1 mm or less of the location of the flush edge that is formed or to be formed although greater distances can be used unless otherwise stated. As another measure of clamping distance, such clamping can be within 30×, more typically within 10×, even more typically within 2× and even possibly at or within 0.1× the thickness of a typical thermoplastic substrate at the location of the flush edge. For example, for a flush edge having a 0.5 cm thickness at its flush edge, the clamping can be within 2× the thickness (i.e., within 1 cm) of the location of the flush edge that is formed. Although such clamping is typically desirable, it may be unneeded, for example where the part has a relatively large thickness. It is additionally contemplated that movements of the laminate, the tool, the fixture or any combination thereof can involve angular movements, rotational movements or otherwise depending upon the complexity of the automated apparatuses and the desired shape or configuration of the flush edges.

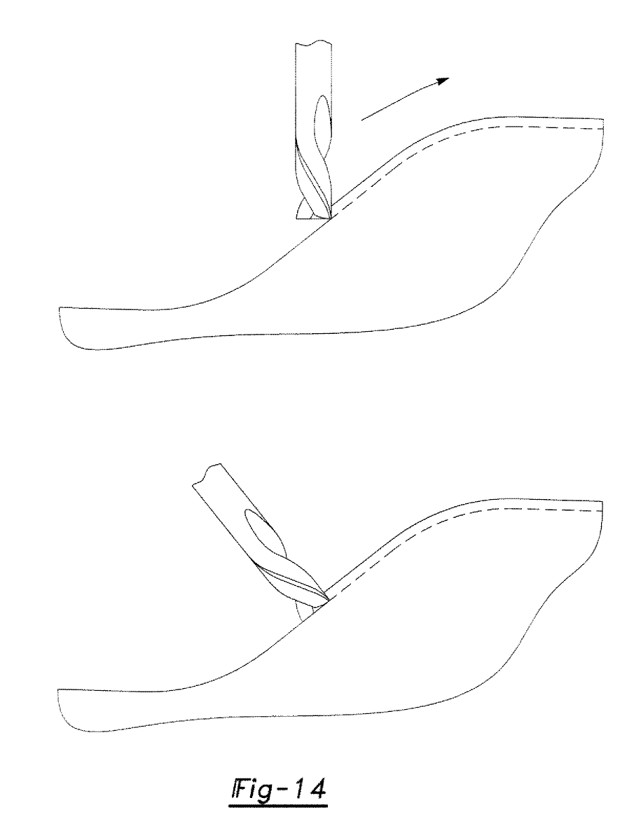

With reference to FIG. 5, an edge forming system according to the present invention is illustrated to have an exemplary machine 60 (e.g., a computer numerical control (CNC) milling machine) and a fixture 62. The machine 60 includes an automated device 64 that rotates a tool 66 about its axis and includes an automated system 68 that can move the tool 66 in three dimensions (i.e., along the dimensions of an X-Y-Z axis). The fixture 62 includes surfaces 70 for clamping of or adjacent locations 72 of a laminate 74 (shown as a three dimensional and generally arcuate, but which could be a planar or 2-dimensional laminate) that is to have flush edges formed according to the present invention. As the tool 66 rotates, the automated system 68 can move the tool to the locations 72 that are to be cut and cut the laminate 74 at those locations to form flush edges and form a part according to a cutting step 58 such as that described with respect to FIG. 1. Typically, the automated system 68 will include computer programming to guide the dimensional movement of the tool 66. As such, the tool can be moved in a linear manner relative to the laminate to form a linear edge or can be moved in two or three dimensions such that the edges follow contours as they extend about the part. It has been found that it is generally preferable to cut contours with movement of the tool as shown in FIG. 14 although other cutting is within the scope of the present invention, unless otherwise stated.

Various cutting systems (e.g., CNC milling machine, rotation cutting machines or the like) may be employed in the practice of the present invention. It may be possible for the cutting system or machine to include mapping of the dimensions of the laminate, the part or both such that the desired cutting locations of the laminate can be automatically determined and cut by the machine or system. The skilled artisan will understand that there are a number of CNC milling machines or other machines having such capability. Examples of potentially suitable systems or machines include: SR-20R manufactured by Star CNC Machine Tool Corp., 123 Powerhouse Rd. P.O. Box 9, Roslyn Heights, N.Y. 11577; CNC Express Milling Machine manufactured by MicroKinetics Corp., 2117-A Barrett Park Dr., Kennesaw, Ga. 30144; System M3X-3S manufactured by CNC Automation. Inc., 13 Columbia Dr., Amherst, N.H. 03031; Flashcut CNC 7000 and 8000 series prototyping and production mills, commercially available from FlashCut CNC, 444 Lake Cook Lake Rd., Suite 17, Deerfield, Ill.; or otherwise.

When a milling machine or similar type of machine or system is employed, the tool is typically rotated at a rate of at least 120 RPMs, although possibly slower, more typically at least 270 RPMs, even more typically at least 400 RPMs, still more typically at least 1000 RPMs and even still more typically at least 3000 RPMs and is also typically rotated at a rate below about 80,000 RPMs although possibly higher, more typically below about 65,000 RPMs, yet more typically less than about about 55,000 RPMs and even more typically less than 30,000 RPMs. Suitable feed rates (i.e., speed of dimensional movement of the tool) are typically at least about 5 cm per minute although possibly slower, more typically at least about 15 cm per minute and even more typically at least about 30 cm per minute and are typically below about 900 cm per minute although possibly higher, more typically below about 300 cm per minute and even possibly below about 100 cm per minute.

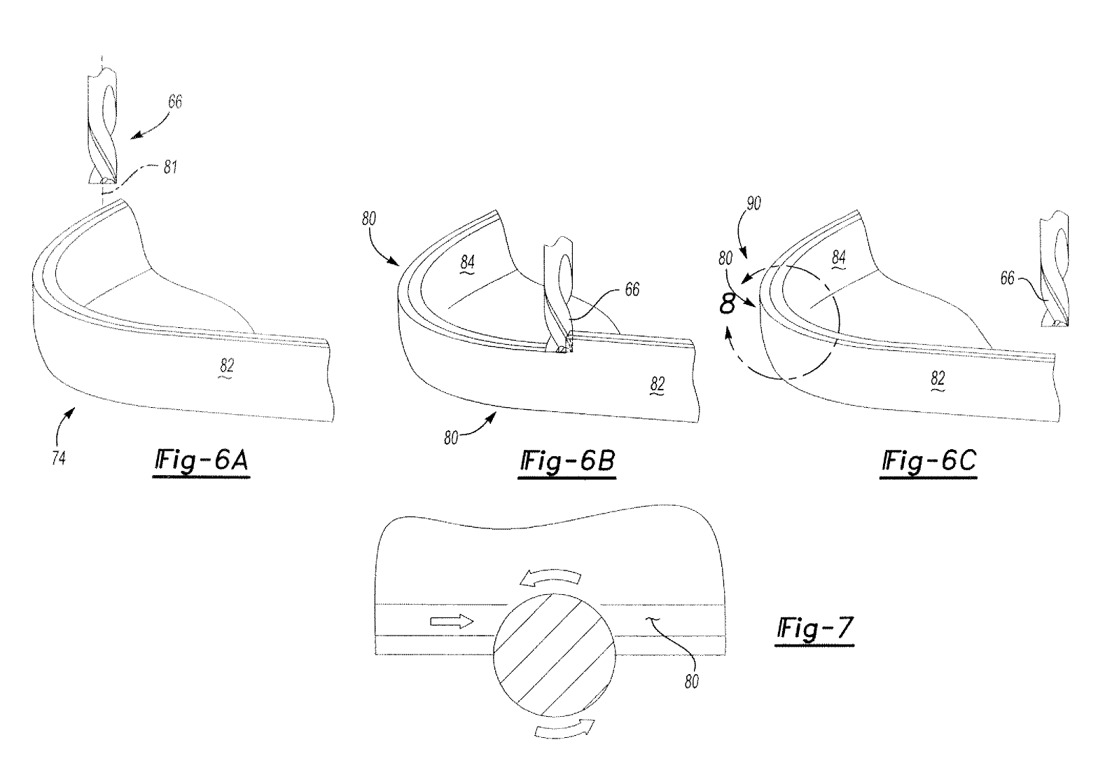

With additional reference to FIGS. 6A-6C, 7 and 13, the tool 66, as it repetitively moves (i.e., rotates) is used to cut the laminate and form one or more flush edges 80 according to the present invention. As shown, an axis 81 of the tool 66 is substantially perpendicular to the edges 80 being formed and the tool 66 is moved along initial edges of the laminate 74 and cuts off the initial edges to form the flush edges 80. Also, as shown, the tool is rotated such that the periphery of the tool enters the laminate 74 by first entering and cutting the fabric 82 and exits the laminate by cutting and exiting the plastic substrate 84. In the embodiment shown, the tool 66 is exclusively dimensionally moved relative to the laminate 74, however, it will be understood that the laminate may also be exclusively dimensionally moved relative to the tool or a combination of dimensional movement of the laminate and the tool may also be employed within the scope of the present invention.

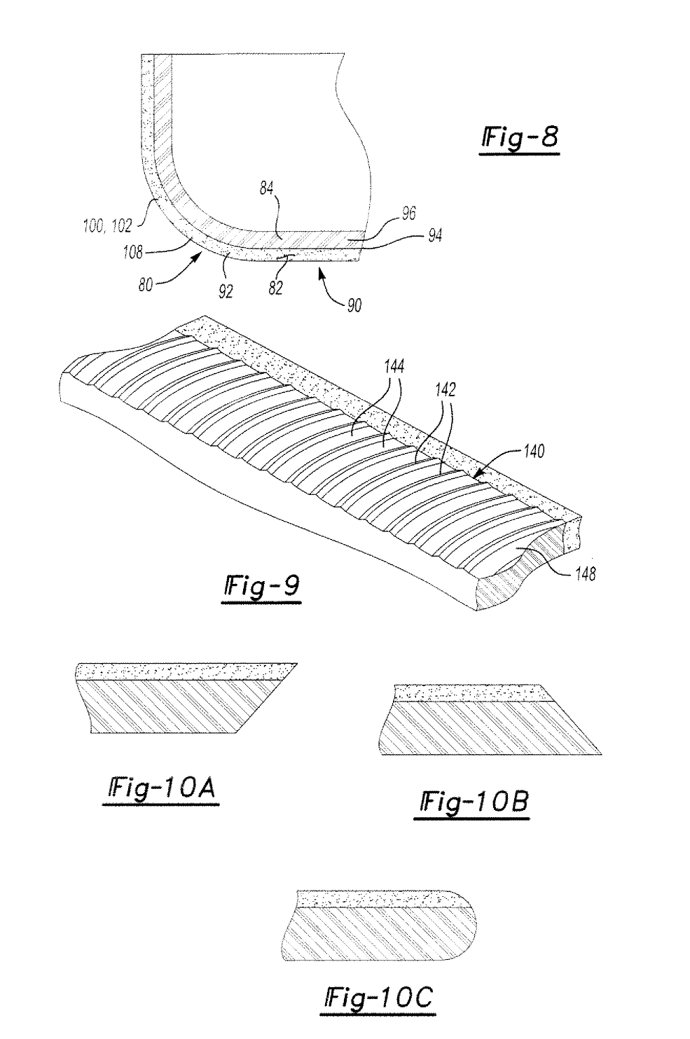

With additional reference to FIG. 8, the fabric 82 and the plastic substrate 84 are cut to form the part 90 such that the part 90 includes one or more flush edges 80 of the part 90 wherein the flush edges 80 have an edge 92 of the fabric flush with an edge 94 and/or surface 96 of the plastic substrate 84. The edge 92 of the fabric can have different configurations, which vary depending upon the actual fabric employed for a particular laminate or part. Thus, the edge 92 of the fabric 82, as defined herein, is whatever portion of the fabric 82 is located at the perimeter 100 of an exposed surface area 102 of the fabric 82. The perimeter of the plastic substrate 84 will typically include an edge 94 and a surface 96 and the edge 92 of the fabric will be substantially flush with the edge 94 and/or surface 96 of the substrate 84 such that the fabric edge 92 will include a portion such as that shown at 108 that is within 1 mm, more typically within 0.5 mm, even more typically within 0.1 mm, even more typically within 0.05 mm and even possibly within 0.005 mm or within 0.0005 mm of the edge 94 and/or surface 96 of the substrate 84.

When a mill or other similar rotating cutting toot is employed, it is generally preferable for the outer periphery of the cutting surfaces of the cutting tool to travel in a circle perpendicular to its axis of rotation and that the diameter of that circle as defined by the cutting tool to be greater than the thickness of the cut flush edge although not required unless otherwise stated. Preferably, the diameter is consistently at least about 1.5×, more typically at least about 2.2×, even more typically at least about 3.0× and even possibly at least about 10× the thickness of the fabric or the cut flush edge, although possibly smaller or larger.

The cutting techniques of the present invention can be used to cut laminates of various thickness to produce parts with flush edges of various thicknesses where such thicknesses include the thickness of the fabric and the substrate. The techniques are particularly useful for forming flush edges having a thickness that is less than about 10 mm although possibly thicker, more typically less than 7 mm and even more typically less than 4 mm. The thickness of the flush edges are also typically greater than about 0.05 mm although possibly thinner, more typically greater than about 0.3 mm and even more typically greater than about 0.5 mm.

In certain embodiments, it may be desirable to pre-cut the fabric (partially or fully) prior to the cutting of the substrate, the fabric or both. Thus, the fabric can be scored with a knife, rotating cutter or the like prior to or as part of the cutting step as described herein.

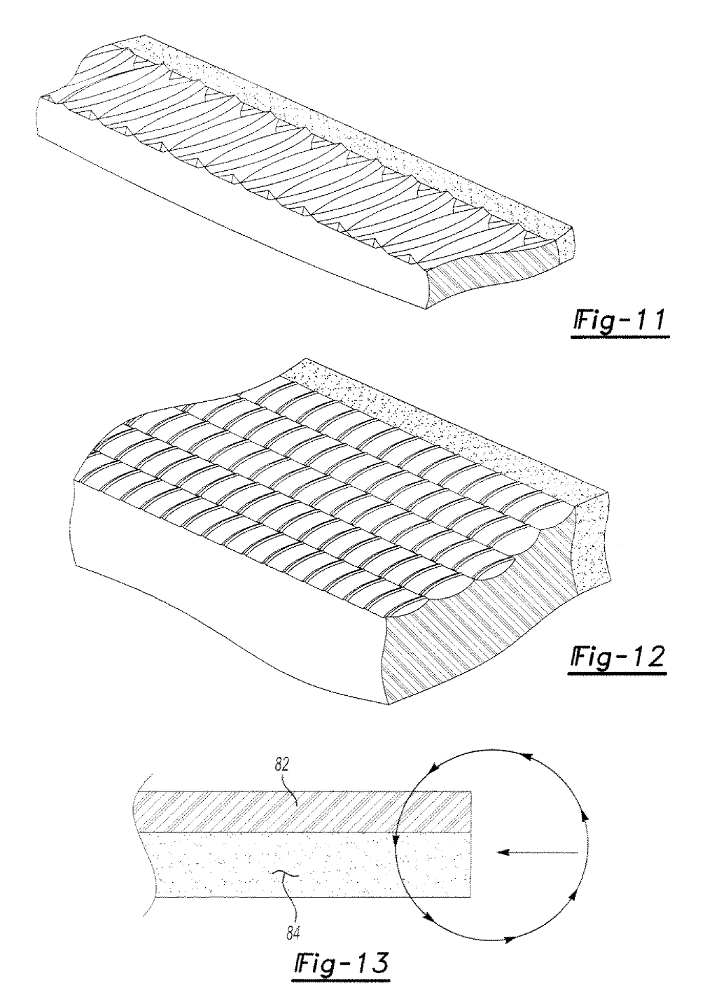

The flush edges of the part will typically include markings or contours indicative of the cutting operation used to form the flush edges. More particularly, the edge of the fabric, the edge and/or surface of the plastic substrate or any combination thereof will typically include markings indicative of the cutting. Such markings can include protrusions, grooves or both that are arcing, S-shaped, zig-zag, wavy. Exemplary markings indicative of mill cutting are shown in FIGS. 9, 11 and 12. As shown in FIG. 9, markings 140 are side-by-side protrusions 142 that are intermittent with side-by-side grooves 144, which may be arced as shown or may be otherwise configured. In the embodiment shown, the protrusions 142, the grooves 144 or both extend substantially entirely across the thickness of the plastic substrate 148. As shown in FIG. 11, typical markings can include protrusions and grooves such as those in FIG. 9 but which may be provided in sets that are arced in opposite directions such that they intersect and/or overlap. As shown in FIG. 12, typically markings can, in addition to above or alternatively, include protrusions or grooves that extend substantially perpendicular to the thickness of the substrate of the part. Although, it may be possible to see markings such as those in FIGS. 9 and 11-12 with the naked eye, it is generally preferably that such markings need to be magnified at least 1.5×, 2×, 4×, 10× or even 40× to be seen by the human eye having 20/20 vision. It is also possible, however, that markings are not definitively visible or distinguishable.

It is additionally contemplated that the flush edges can take numerous configurations as needed or desired. Flush edge configurations, in one embodiment of the invention, can be changed by using different cutting tools. For example, different types of mills can produce different shaped flush edges. Moreover, systems (e.g., CNC machines) can be configured to move (e.g., angle the tools to create differently shaped flush edges. Examples of flush edges are shown in FIGS. 8 and 10A-10C. A standard flush edge 80 is illustrated in FIG. 8. Chamfered or slanted flush edges are illustrated in FIGS. 10A and 10B. An arcuate flush edge is illustrated in FIG. 10C.

The skilled artisan will understand that various different cutters and cutting techniques can be used within the scope of the present invention and that some degree of experimentation will be desirable to choose an appropriate cutter or mill for a laminate depending upon the fabric and/or plastic of that laminate. One potential technique for use with the present invention is to use multiple different cutters or mills to form flush edges on a single part and such cutters or mills may be automatically interchanged using some of the cutting machines discussed herein or other machines. Another potential technique includes the use of a left hand cutter and a right hand cutter to assure the cutter enters the fabric and exits the substrate as related to feed direction. As another example, markings such as those shown in FIG. 12 might be formed by multiple passes with a beveled or ball end mill to form the flush edge.

In addition to the above, it is contemplated that the backing materials of the fabrics of the present invention, in certain embodiments, can suffice as the substrates of the laminates. As such, a fabric with a relatively rigid backing as described herein may be cut to form one or more flush edges in accordance with the present invention.

It is generally contemplated that the part of the present invention can serve as a member (e.g., panel, portion, flap, closure panel or the like) of several different products or articles of manufacture. Preferably, the parts have at least one surface, particularly the fabric surface, facing outwardly from whatever end product or articles the parts are used for such that the parts can provide a desirable aesthetic appearance or functional benefit (e.g., grippability or protection) to the article, The articles of the present invention may be used in various end products. For example the parts can be used for consumer electronics such as cell phones; PDAs; notebook and desktop computers; headsets; audio equipment such as disc players, wireless equipment, MP3 players; video equipment such as televisions and remote DVD players or other types of consumer electronics. In one particular preferred embodiment, the parts are employed as top or bottom covers for a laptop computer. The parts may also be used in premium packaging such as packaging for cosmetics, disc storage units or the like. It is also contemplated that the parts may be used for appliances or household goods such as laundry machines, lamps, furniture, refrigerators or the like. Moreover, the parts can be employed in automotive applications such as for door panels, trim panels, instrument panels, automotive consoles, headliners, close-out panels, visors, combinations thereof or the like.

### EXAMPLES

### Example 1

A flat laminate is formed of 2 mm thickness that is comprised of 0.3 mm synthetic leather on one side integrally bonded to 1.7 mm PC/ABS plastic on the other side. The laminate is clamped in a fixture such that 3.0 mm of the laminate extends above or beyond the fixture. A 0.625 inch diameter 4-flute, high speed steel, flat end mill has its axis aligned with the fabric surface of the laminate. The end mill is turned at 3000 rpm and is fed at a rate of 10 inches per minutes The orientation of the laminate and cutting tool is such that the laminate is cut with the end of the flat end mill such that the resulting part edge is substantially perpendicular to the axis of the cutting tool. Rotational direction and feed direction are matched such that the leading edge (or cutting edge) of the tool is entering the laminate on the fabric side and exiting the laminate on the plastic side. With reference to the fabric side of the laminate, this is commonly called climb cutting. Two passes along the edge of the laminate are used. The first pass is a rough cut and removes approximately 2.0 mm of the 3.0 mm of the laminate that extends above the fixture. The cutter is returned to the starting position and a second pass is made which removes an additional 0.5 mm of the laminate edge extending above the fixture, thus producing the finish cut of the part edge. The result is a high quality cut edge with the edge of the fabric having few or no frays and the fabric edge and the plastic edge being substantially exactly or exactly flush along the entire cut edge of the part.

### Example 2

In example 2, a part is formed for a top cover of a laptop computer. Accordingly, synthetic leather is laminated to a thin film of PC/PET and thermoformed into the shape of the laptop top cover and cut in a matched metal cutter with the edge about 5 mm longer than the designed edge of the part thereby forming a fabric insert. A laminate is then produced by backmolding the synthetic leather insert with PC/ABS resin such that the synthetic leather and substrate both extend about 5 mm beyond the designed or intended edge of the part. The laminate is produced to have approximately 2.0 mm thickness. The molded laminate with long edges is secured in a fixture comprised of a cavity section and a core section that support the molded laminate during the machining of its edges to form the part. The cavity and core portions of the fixture support the edge of the molded laminate on both sides to a point about 0.1 mm short of the designed edge of the final part. The fixtured laminate is clamped in a CNC machine. Multiple toolpaths are programmed into the CNC machine. Left and right hand down-flute, two-flute, solid carbide, flat end cutters of 6.35 mm diameter were used in the initial toolpaths to remove all but the last 0.5 mm of the excess stock and control the cutoff material from re-entering the subsequent cut paths. This same cutter was also used in finish cutting some deep cut areas to control chipping and cut quality. Most finish cuts were made with left and right hand up-flute, two-flute, solid carbide, flat end cutters of 6.35 mm diameter. Finish cut toolpaths had the centerline of the cutter in contact with the fabric surface edge and the feed direction and rotation were paired to have the leading edge of the cutter entering the fabric side of the part or to climb cut with respect to the fabric side of the laminate. Additional finish cut toolpaths were stepped over from the initial finish cut toolpath in the direction of the fabric surface toward the plastic substrate side of the laminate where needed. Toolpaths included ramp-in and ramp-out features to ease the cutter into and out of the laminate. Toolpaths were programmed to move the cutter up vertical or contoured walls so the cutting motion was from the fabric side into the plastic side of the laminate. Angled or beveled edges were cut with a ball end mill and multiple step-overs. Feed rates were generally in the range of 125 to 250 cm per minute and cutter rotational speed was 20,000 rpm. The orientation of the laminate edge and the cutting tool is such that the laminate is cut with the end of the cutter such that the resulting part edge is perpendicular to the axis of the cutting tool.

### Example 3

A part was formed as a bottom cover of a laptop computer. The bottom cover of the laptop computer was molded and cut as described in Example 2 with the exception that a portion of the fabric was scored prior to machining of the edges. Scoring was accomplished by placing the molded laminate into a scoring fixture and applying a clamp to hold it in place. The specified areas of the part were then scored with a rotating disc cutter or a hand held knife such that the knife cut through the fabric but only slightly into the plastic substrate. The part was then removed from the scoring fixture and machined as described in Example 2.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A process of forming a molded plastic part, comprising:
providing a layer of material;
attaching the layer of material to a plastic substrate to form a laminate;
cutting the layer and the plastic substrate to form the part such that the part includes one or more edges having an edge of the layer flush with an edge and/or surface of the plastic substrate, wherein:
i. the step of cutting is accomplished with a tool; and
ii. the tool is being moved in rapid repetitive motions for assisting in accomplishing the cutting, the rapid repetitive motions selected from rotations, vibrations, oscillations or a combination thereof.

2. A process as in claim 1 wherein, during cutting, the tool is dimensionally moved by a computer controlled system.

3. A process as in claim 2 wherein the computer controlled system is a CNC machine.

4. A process as in claim 1 wherein the tool is a mill and the rapid repetitive motions are rotations of the mill about an axis of the mill.

5. A process as in claim 1 wherein the axis of the tool is substantially perpendicular to the surface of the plastic substrate during cutting of the layer and the plastic substrate as the surface is formed.

6. A process as in claim 1 wherein the step of attaching the substrate to the layer includes backmolding the substrate to the layer.

7. A process as in claim 6 wherein:
i. the fabric is provided as a fabric insert within a mold of an injection molding machine;
ii. the fabric insert is comprised of a fabric and a backing; and
iii. the fabric insert has a predetermined 3-dimensional shape within one or more contours that correspond to and nest with one or more contours of the mold.

8. A process as in claim 1 wherein the tool the laminate or both are configured for automated movement in at least one dimension within a 3-dimensional space during the rapid repetitive motions, the automated movement being separate and independent from the rapid repetitive motions, to move the tool, the laminate or both relative to each other such that the tool cuts the laminate to form the one or more edges.

9. A process as in claim 1 wherein either:
i. the edge of the fabric, the edge and/or surface of the plastic substrate or any combination thereof include markings indicative of the cutting; or
ii. for cutting, the periphery of the tool enters the laminate by cutting the fabric and exits the laminate by cutting the plastic substrate.

10. A process of forming a molded plastic part, comprising:
providing a fabric, wherein:
i. the fabric is provided as a fabric insert within a mold of an injection molding machine;
ii. the fabric insert is comprised of a fabric and a backing; and
iii. the fabric insert has a predetermined 3-dimensional shape within one or more contours that correspond to and nest with one or more contours of the mold;
attaching the fabric to a plastic substrate to form a laminate, wherein:
i. the step of attaching includes molding a plastic material within the mold to form a plastic substrate component adhered to the fabric insert; and
ii. the fabric insert overlays the substrate component;
cutting the fabric and the plastic substrate to form the part such that the part includes one or more edges having an edge of the fabric flush with an edge and/or surface of the plastic substrate, wherein:
i. the step of cutting is accomplished with a tool;
ii. the tool is being moved in a rapid repetitive motions for assisting in accomplishing the cutting, the rapid repetitive motions selected from rotation, vibration, oscillation or a combination thereof;
iii. the tool, the laminate or both are configured for automated movement in at least one dimension within a 3-dimensional space during the rapid repetitive motions, the automated movement being separate and independent from the rapid repetitive motions to move the tool, the laminate or both relative to each such that the tool cuts the laminate to form the one or more edges;
iv. the edge of the fabric, the edge and/or surface of the plastic substrate or any combination thereof include markings indicative of the cutting; and
v. for cutting, the periphery of the tool enters the laminate by cutting the fabric and exits the laminate by cutting the plastic substrate.

11. A process as in claim 10 wherein the rapid repetitive motions are rotations.

12. A process as in claim 10 wherein the fabric is a synthetic leather or suede layered with a woven polymeric material.

13. A process as in claim 10 wherein, during cutting, the tool is dimensionally moved by a computer controlled system.

14. A process as in claim 13 wherein the computer controlled system is a CNC machine.

15. A process as in claim 10 wherein the tool is a mill and the rapid repetitive motions are rotations of the mill about an axis of the mill.

16. A process as in claim 10 wherein the axis of the tool is substantially perpendicular to the surface of the plastic substrate during cutting of the fabric and the plastic substrate as the surface is formed.

17. A part, comprising:
a plastic substrate having an edge and/or surface;
a fabric having an edge that is substantially flush with the edge and/or surface of the plastic substrate, wherein:
i. the edge of the fabric, the edge and/or surface of the substrate or any combination thereof include markings indicative of cutting of the fabric and substrate by a tool undergoing rapid repetitive motions.

18. A part as in claim 17 wherein the rapid repetitive motions are rotations and the markings are intermittent protrusions and grooves.

19. A part as in claim 18 wherein the protrusions and grooves are arcuate as they extend across the thickness of the substrate.

20. A part as in claim 19 wherein the markings are only visible to the naked eye under magnification.

21. A process as in claim 10 wherein the fabric is pre-cut as part of the cutting of the fabric and the substrate.

22. A process as in claim 1 wherein the flush edge is formed with multiple passes of the tool.

23. A process as in claim 1 wherein the cutting step includes scoring the fabric.
